(19) United States
(12) Patent Application Publication
(10) Pub. No.: US 2004/0038852 A1
(43) Pub. Date: Feb. 26, 2004

(54) Liquid detergent compositions for laundering colored fabrics

(75) Inventors: Marena Dessette Brown, Cincinnati, OH (US); Abdennaceur Fredj, Loveland, OH (US); Fredric Barton Rea, Lawrenceburg, IN (US)

Correspondence Address: THE PROCTER & GAMBLE COMPANY, INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter & Gamble Company

(21) Appl. No.: 10/225,257

(22) Filed: Aug. 21, 2002

(51) Int. Cl. C11D 1/00

(52) U.S. Cl. 510/499

(57) ABSTRACT

A liquid laundry detergent having improved color care properties when used to launder colored fabrics. The composition comprises an effective amount of a chlorine scavenger, a polymeric dye transfer inhibiting agent, a detersive surfactant, and is substantially free of triazinylaminostilbene optical brightener. Methods of using such compositions for cleaning colored fabric.

### FIELD OF INVENTION

The present invention relates to liquid laundry detergents compositions which can be used for washing colored fabrics and which contain additives that provide color-enhancing benefits.

### BACKGROUND OF THE INVENTION

Commercially available are various liquid laundry detergents directed at select benefits for clothing and textile washing. Some detergents are directed at deep cleaning (for highly soiled or industrial fabrics), others at gentle cleaning (for delicate fabrics or lightly soiled garments), others at bleaching white or light colored clothing. Also available are liquid laundry detergents marketed for the cleaning and/or protection of colored fabrics and clothing.

Colored fabrics are a sensitive class of fabrics warranting special care during the normal wash cycle. For instance, colored fabrics have a tendency to release dye into the wash solution which can cause fading. This released dye can also be transferred to other fabrics in the same wash solution or even to other differently-colored parts of the same fabric. To help reduce the negative affects of laundering colored fabrics, color-care laundry detergents often contain components that are useful for inhibiting or reducing dye-transfer between fabrics during the wash. One example of components that are known to inhibit or reduce dye-transfer between fabrics during the wash is a copolymer of N-vinylimidazole and N-vinylpyrrolidone, commonly referred to as “PVPVI” or “PVP/PVI.” Another example is polyvinylpyrrolidone, “PVP.”

However, even when utilizing a polymeric dye transfer inhibiting agent such as PVPVI or PVP, colored fabrics may still be faded by the free chlorine present in most residential water sources. Chlorine is used in many parts of the world to purify water. To make sure that the water is safe, a small residual amount, typically about 1 part per million (ppm), of chlorine is left in the water. It has been found that even this small amount of chlorine can cause fading of chlorine-sensitive fabric dyes. In a typical wash, there is usually enough soil on the fabrics to scavenge residual chlorine and minimize damage to chlorine-sensitive dyes. However, in the rinse cycle the soil levels are greatly reduced, and chlorine-sensitive dyes can fade after multiple laundering cycles.

Therefore, it is also known to use chlorine scavengers, such as monoethanolamine, to reduce the level of free chlorine in the wash solution and correspondingly reduce the fading associated with colored fabrics. Although the currently implemented levels of chlorine scavengers, such as monethanolamine, may carry over in part to the rinse cycle with water retained in the fabric fibers from the wash cycle, the level of scavenger carryover is generally too low to be efficacious. Therefore, even though the colored fabrics are protected by the chlorine scavenger during the wash cycle, the same fabrics may still be faded during the rinse cycle by the free chlorine present in the rinse solution.

Optical brighteners, or fluorescent whitening agents, are often used in laundry detergents to provide appearance benefits. Optical brighteners work by absorbing ultraviolet light and re-emitting most of the absorbed energy as blue fluorescent light between ca. 400 and 500 nm. In daylight, optical brighteners can thus compensate for the aesthetically undesirable yellowish cast found in white or light colored fabrics and give such fabrics a dazzling white. However, when optical brighteners are used in laundering colored fabrics, there often results an undesirable color hue shift. Even more importantly, it is also known that certain optical brighteners, when used in conjunction with a polymeric dye transfer inhibiting agent, often complex with the polymeric dye transfer inhibiting agent, resulting in an undesirably cloudy product.

Notwithstanding prior art attempts to solve the color care problems (including fading and dye transfer) during fabric laundering, there is a continuing need to identify detergent compositions, detergent composition additives, and fabric laundering methods which are especially effective for laundering colored fabrics. There is further a need to identify detergent compositions wherein the color-care components do not negatively interact with one another.

In short, there is a continuing need to develop liquid laundry detergents that provide a combined strategy for color care, including; (a) reduction in free dye concentration during the wash cycle, resulting in less color fading and less discoloration of fabrics by dye redeposition; (b) reduction of dye damage and subsequent fading and color changes associated with oxidation by chlorine in both the wash and the rinse cycles; and (c) improvement in the compatibility of polymeric dye transfer inhibiting agents with typical liquid laundry detergent formulations.

### SUMMARY OF THE INVENTION

It has now surprisingly been discovered that the combination of an effective amount of a chlorine scavenger, a polymeric dye transfer inhibiting agent, and less than 0.02% triazinylaminostilbene optical brightener is useful for protecting colored textiles during the laundering process. It has been discovered that such combination protects the richness and vibrancy of colors.

The present invention relates to liquid laundry detergents comprising

a) an effective amount of a chlorine scavenger;

b) a polymer dye transfer inhibiting agent;

c) a surfactant; and

d) wherein the composition is substantially free of triazinylaminostilbene optical brightener.

The present invention also relates to methods of using such detergents for laundering colored fabrics and/or clothing and protecting the color of such fabrics and/or clothing. Said methods generally comprise the step of adding a safe and effective amount of the composition to the drum of a washer during the laundering process.

These and other features, aspects, and advantages of the present invention will become evident to those skilled in the art from a reading of the present disclosure.

All documents cited are, in relevant part, incorporated herein by reference; the citation of any document is not to be construed as an admission that it is prior art with respect to the present invention.

### DETAILED DESCRIPTION OF THE INVENTION

While the specification concludes with the claims particularly pointing and distinctly claiming the invention, it is believed that the present invention will be better understood from the following description.

All percentages and ratios used herein are by weight of the total composition and all measurements made are at 25° C., unless otherwise designated.

The compositions of the present invention can include, consist essentially of, or consist of, the components of the present invention as well as other ingredients described herein. As used herein, “consisting essentially of” means that the composition or component may include additional ingredients, but only if the additional ingredients do not materially alter the basic and novel characteristics of the claimed compositions or methods.

All percentages, parts and ratios are based upon the total weight of the liquid laundry detergent compositions of the present invention, unless otherwise specified. All such weights as they pertain to listed ingredients are based on the active level and, therefore, do not include carriers or by-products that may be included in commercially available materials, unless otherwise specified.

It has now been found that detergent compositions containing a combination of a higher level of chlorine scavenger with a detersive surfactant and a polymeric dye transfer inhibitor, in the absence, or near absence, of triazinylaminostilbene optical brightener, are useful for providing improved colored fabric laundering results.

Without being limited by theory, it is believed that the higher level of chlorine scavenger in the formulation reduces the bleaching affect of free chlorine in both the wash cycle and the rinse cycle, as opposed to prior detergents which generally reduced the bleaching affect during only the wash cycle. In addition, it is believed that such higher levels of chlorine scavengers, in combination with a polymeric dye transfer inhibitor, provide advantages to which the prior art is unaware. Furthermore, the absence, or near absence, of triazinylaminostilbene optical brightener reduces the cloudiness of the formulation attributable to the interaction between the optical brightener and the polymeric dye transfer inhibitor. Cloudiness is especially undesirable in liquid detergent compositions.

Therefore, the liquid laundry detergent compositions of the present invention contain an effective amount of a chlorine scavenger, a polymeric dye transfer inhibiting agent, and a detersive surfactant. The compositions of the present invention contain less than 0.02% of triazinylaminostilbene optical brightener.

The compositions herein may also include a wide variety of other ingredients. The compositions of the present invention, are described in detail hereinafter.

I. Chlorine Scavenger

The compositions of the present invention comprise a chlorine scavenger. As used herein, the term “chlorine scavenger” refers to any compound or material that is capable of de-activating free chlorine (Cl₂ and/or hypochlorite) in solution or at the fabric/solution interface. De-activation can take place either by direct reduction of chlorine species by the chlorine scavenger, such as to chloride, or by combination of the chlorine scavenger with a chlorine species to yield a less oxidizing species for dyes or chlorine bleach-sensitive textile fibers than free chlorine. Such less oxidizing species include for example chlorine adducts, e.g., chloramines when the chlorine scavenger contains an amino nitrogen moiety.

Chlorine scavengers useful herein typically contain either an atom, site or moiety that is readily halogenated, e.g., a trivalent nitrogen, or another non-nitrogen electron-rich site or moiety which is readily susceptible to attack by chlorine or hypochlorite.

Chlorine scavengers useful herein include nonpolymeric types which tend to be the most rapidly reacting, and polymeric types, which can be preferred on account of lower tendency to be associated with odors. Also the chlorine scavenger can be nitrogen-containing or nitrogen-free.

Nonpolymeric, Nitrogen Containing Chlorine Scavengers

For example, an especially preferred nonpolymeric nitrogen containing chlorine scavenger is monoethanolamine. More generally a class of preferred nonpolymeric nitrogen containing chlorine scavengers to which monoethanolamine belongs are nonpolymeric nitrogen containing chlorine scavengers selected from hydroxyfunctional primary amines, hydroxyfunctional secondary amines and mixtures thereof wherein such hydroxyfunctional amines comprise from two to eight carbon atoms. These highly preferred chlorine scavenger compounds have the unusual combination of properties of simultaneously having chlorine scavenging properties, polar solvent properties, buffering properties, and the capacity to act as neutralizing agents for the acid form of anionic detersive surfactants or for fatty acids. Other chlorine scavengers in this class include diethanolamine, isopropanolamine, and mixtures of such lower alkanolamines with monoethanolamine or with each other.

Preferably for rapid reaction, the chlorine scavenger is a nonpolymeric chlorine scavenger, or, when a polymeric chlorine scavenger is selected, it is selected on the basis of being relatively rapidly reacting with free chlorine as compared with other polymers.

Other nonlimiting examples of nonpolymeric nitrogen containing chlorine scavengers useful herein include: ammonia or ammonium salts such as ammonium nitrate, sulfate or carbonate, nonpolymeric amines, imines, amidines, acrylamides, and mixtures thereof. Suitable amines for example include 2-methyl pentamethylene diamine (MPMD), triethylene tetramine (TETA) and dimethylamidopropylene (bis-DMAPA), diethylene triamine (DETA). Yet other nonpolymeric nitrogen containing chlorine scavengers include aminomethanephosphonic acid or its water soluble salts where the acid has the formula:

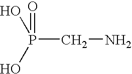

Still other nonpolymeric nitrogen containing chlorine scavengers include amino acids (whether natural or synthetic) or their water-soluble salts, aminocarboxylic acids or their water-soluble salts, sulfamic acid or its water-soluble salts, and mixtures of any of the foregoing compounds. When such nitrogen-containing chlorine scavenger can be used as a neutralizer or counter-ion for an anionic species of the composition, such as an anionic surfactant, this provides another salt form in which the chlorine scavenger can be introduced into the composition. In such a situation, for formula accounting purposes, the aminofunctional cation of the chlorine scavenger will be accounted as a chlorine scavenger component and the surfactant anion as a surfactant component of the composition. Other less preferred nitrogen containing chlorine scavengers include hydrazine or its derivatives.

It is preferred that the volatility of nonpolymeric nitrogen containing chlorine scavenger compounds be relatively low, e.g., normal boiling points of about 50 deg. C or higher, preferably 80 deg. C or higher. Substitution of an aminofunctional (e.g., trivalent nitrogen containing nonpolymeric) chlorine scavenger with —OH moieties helps reduce odor and volatility as compared to the corresponding unsubstituted amine.

Polymeric, Nitrogen Containing Chlorine Scavengers

Nonlimiting examples of polymeric nitrogen containing chlorine scavengers useful herein include any suitable nitrogen containing polymeric derivatives, such as polyamines, polyimines, polyamidines, polyacrylamides, proteins, polypeptides of natural or synthetic origin, such as hydrolyzed vegetable proteins, derivatives of chitin or chitosan, and mixtures thereof.

Polyamines are addition or condensation products from multivalent aliphatic amines and compounds with several groups capable of reacting, for example, epichlohydrin or alkylene dihalides. Therefore they contain several secondary, tertiary, or even quaternary nitrogen atoms; moreover they may further optionally comprise one or more hydroxyl groups in the molecule. They are hydrophilic, polar compounds that behave as polyelectrolytes and are water soluble, inasmuch as they do not contain large hydrophobic groups in the molecule. The amines and polyamines exhibit basic reaction in aqueous solution. Suitable compounds, for example, are described in U.S. Pat. No. 2,969,302 to Nalco Chemical, issued Jan. 1, 1961.

Polyimines, especially polyethyleneimines, may have desirable reactivity and physical attributes. Polyethyleneimines are obtained by acid-catalyzed polymerization of ethyleneimine and can be modified by urea and epichlorhydrin or dichloretheane. Polyimines and polyethyleneimines can contain primary, secondary, or tertiary amino groups as well as quarternary ammonium groups. Aqueous solutions of imines or polyimines show basic reaction.

Polyamidines and polyamineamides contain amino and amido groups in the molecule at the same time. They are made, for example, by condensation of multibasic acids, for example, dibasic, saturated, aliphatic C₃ to C₈ acids and polyamines as well as with compounds that contain several groups capable of reacting, such as for example epichlorhydrin. These compounds also demonstrate basic reaction in aqueous solution. Suitable compounds, for example, are described in U.S. Pat. No. 2,926,154 to Hercules Powder Company, issued Feb. 23, 1960.

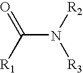

Amides are compounds with adjacent carbonyl and amine moieties, as exemplified in the above structure. When R₁ is C═C this is acrylamide, the basis for the polyacrylamides. Polyacrylamides having amino groups and molecular weights up to several million are also suitable for use herein. By building in carboxyl groups, which are formed, for example, by partial hydrolysis, anionic polyacrylamides are obtained in addition to amido groups, while polyacrylamides containing amino groups exhibit basic reaction in aqueous solution.

Other Non-Aminofunctional Chlorine Scavengers

Other non-aminofunctional chlorine scavengers useful herein include anions of reducing materials such as sulfite, bisulfite, thiosulfite, thiosulfate, iodide, nitrite, etc and antioxidants such as carbamate, ascorbate, etc. and mixtures thereof. Additionally, conventional non-chlorine scavenging anions like sulfite, bisulfite, carbonate, bicarbonate, nitrate, acetate, benzoate, citrate, formate, lactate, salicylate, etc. and mixtures thereof can be used with any water-soluble counterions. Yet other non-aminofunctional chlorine scavengers include 2,2-oxydisuccinate, sodium perborate, inorganic peroxo-compounds, nitric acid and 4-hydroxybenzoic acid; alkyl benzoic acids and alkyl benzene sulfonic acids having a short chain alkyl substituent such that they are not appreciably active as surfactants, e.g., methyl.

Salts of phosphorous acid and sodium hypophosphite are also useful herein as chlorine scavengers. In addition, chlorine scavengers such as the hydroxysulfinate adducts of aliphatic, aromatic, or heterocyclic mono- or dialdehyde or ammonia adduct thereof, disclosed in U.S. Pat. No. 4,786,434, to Gunter, et al. Issued Nov. 22, 1988, may also be used herein.

Levels of Chlorine Scavenger

The compositions preferably contain from about 0.1% to about 20%, more preferably from about 0.1% to about 10%, more preferably from about 1% to about 10%, more preferably from about 1.5% to about 5% of the chlorine scavenger. The level selected is preferably that which adequately eliminates (or nearly eliminates) ambient chlorine levels in the water supply (approximately 0.8 ppm average in United States' water supplies) for both the wash cycle and the rinse cycle of a typical United States washing machine. The actual amount of chlorine scavenger needed will vary based on the molecule selected, the extent of the wash water carryover to the rinse, product dosage, and level of residual chlorine in the rinse water. For example, under typical U.S. washing conditions, greater than approximately 1.5%, by weight of the composition, of monoethanolamine in a liquid laundry detergent would be needed to scavenge the chlorine in the rinse water, assuming approximately 5% of the wash water is carried over to the rinse cycle and approximately 0.8 ppm of residual chlorine in the rinse water.

Mixtures of more than one chlorine scavenger may be used. Suitable chlorine scavengers for use herein are commercially available from a number of sources, e.g., BASF, Union Carbide, Dow Chemical, Jefferson Chemical Company, Allied Chemical Company, and Huntsman.

Odor Suppression with Aminofunctional Chlorine Scavengers

In order to suppress any malodor associated with the use of certain aminofunctional chlorine scavengers, packages and perfumes such as those disclosed in PCT Published Application WO 00123274 A1, to Kaiser, et al., published Apr. 5, 2001, may be used in conjunction with compositions according to the present invention.

II. Polymeric Dye Transfer Inhibiting Agent

The compositions of the present invention may contain a polymeric dye transfer inhibiting agent. Polymeric dye transfer inhibiting agents are known in the art for reducing or preventing dye-transfer during the laundering process. Polymeric dye transfer inhibiting agents useful herein include polyvinylpyrrolidone and copolymers thereof.

a) Polyvinylpyrrolidone

Polyvinylpyrrolidone (“PVP”) has an amphiphilic character with a highly polar amide group conferring hydrophilic and polar attracting properties, and also has apolar methylene and methane groups, in the backbone and/or the ring, conferring hydrophobic properties. The rings may also provide planar alignment with the aromatic rings, in the dye molecules. PVP is readily soluble in aqueous and organic solvent systems. PVP is commercially available from BASF Corporation, Parsippany, N.J. in either powder or aqueous solutions in several viscosity grades.

b) Copolymers of N-vinylpyrrolidone and N-vinylimidazole

The detergent compositions of the present invention may also utilize a copolymer of N-vinylpyrrolidone and N-vinylimidazole (also abbreviated herein as “PVPVI”). It has been found that copolymers of N-vinylpyrrolidone and N-vinylimidazole can provide excellent dye transfer inhibiting performance when utilized in the compositions of this invention.

In a preferred embodiment, the copolymer of N-vinylpyrrolidone and N-vinylimidazole polymers has an average molecular weight range from 5,000 to 1,000,000, more preferably from 5,000 to 200,000. A highly preferred copolymer for use in detergent compositions according to the present invention has an average molecular weight range from 5,000 to 50,000, more preferably from 8,000 to 30,000 and, most preferably from 10,000 to 20,000. The average molecular weight range is determined by light scattering as described in Barth J. H. G. and Mays J. W. Chemical Analysis Vol 113. “Modern Methods of Polymer Characterization.”

The copolymers of N-vinylpyrrolidone and N-vinylimidazole useful in the present invention can have a molar ratio of N-vinylimidazole to N-vinylpyrrolidone from 1:1 to 0.2:1, more preferably from 0.8:1 to 0.3:1, most preferably from 0.6:1 to 0.4:1. It should be understood that the copolymer of N-vinylpyrrolidone and N-vinylimidazole can be either linear or branched. Copolymers of poly(N-vinyl-2-pyrollidone) and poly(N-vinyl-imidazole) are commercially available from a number of sources including BASF and International Specialty Products. U.S. Pat. No. 6,391,995 Issued May 21, 2002 to Muragan, assigned to Reilly Industries, Inc. teaches process for preparing dye-transfer inhibiting polymers. Such process is preferred for preparation of the PVP and PVPVI agents herein.

Preferably, the polymeric dye transfer inhibiting agent is a copolymer of poly(N-vinyl-2-pyrollidone) and poly(N-vinyl-imidazole) (commonly referred to as PVPVI).

The compositions preferably contain from about 0.001% to about 10%, more preferably from about 0.01% to about 5%, even more preferably from about 0.05% to about 1%, by weight of the composition, of the polymeric dye transfer inhibiting agent.

Mixtures of more than one polymeric dye transfer inhibiting agent may be used.

III. Detersive Surfactant

The detergent compositions herein comprise from about 1% to 80%, by weight of the composition, of a detersive surfactant. Preferably such compositions comprise from about 5% to 50%, by weight of the composition, of this surfactant. Detersive surfactants utilized can be of the anionic, nonionic, zwitterionic, amphoteric or cationic type or can comprise compatible mixtures of these types. Detergent surfactants useful herein are described in U.S. Pat. No. 3,664,961, Norris, issued May 23, 1972, U.S. Pat. No. 3,919,678, Laughlin et al., issued Dec. 30, 1975, U.S. Pat. No. 4,222,905, Cockrell, issued Sep. 16, 1980, and in U.S. Pat. No. 4,239,659, Murphy, issued Dec. 16, 1980. All of these patents are incorporated herein by reference.

Anionic surfactants which suitable for use herein include the water-soluble salts, preferably the alkali metal, ammonium and alkylammonium salts, of organic sulfuric reaction products having in their molecular structure an alkyl group containing from about 10 to about 20 carbon atoms and a sulfonic acid or sulfuric acid ester group. (Included in the term “alkyl” is the alkyl portion of acyl groups.) Examples of this group of synthetic surfactants are a) the sodium, potassium and ethanolamine alkyl sulfates, especially those obtained by sulfating the higher alcohols (C₈-C₁₈ carbon atoms) such as those produced by reducing the glycerides of tallow or coconut oil; b) the sodium, potassium and ethanolamine alkyl polyethoxylate sulfates, particularly those in which the alkyl group contains from 10 to 22, preferably from 12 to 18 carbon atoms, and wherein the polyethoxylate chain contains from 1 to 15, preferably 1 to 6 ethoxylate moieties; and c) the sodium and potassium alkylbenzene sulfonates in which the alkyl group contains from about 9 to about 15 carbon atoms, in straight chain or branched chain configuration, e.g., those of the type described in U.S. Pat. Nos. 2,220,099 and 2,477,383. Especially valuable are linear straight chain alkylbenzene sulfonates in which the average number of carbon atoms in the alkyl group is from about 11 to 13, abbreviated as C₁₁₋₁₃ LAS.

Preferred nonionic surfactants are those of the formula R¹(OC₂H₄)ₙOH, wherein R¹ is a C₁₀-C₁₆ alkyl group or a C₈-C₁₂ alkyl phenyl group, and n is from 3 to about 80. Particularly preferred are condensation products of C₁₂-C₁₅ alcohols with from about 5 to about 20 moles of ethylene oxide per mole of alcohol, e.g., C₁₂-C₁₃ alcohol condensed with about 6.5 moles of ethylene oxide per mole of alcohol. Additional suitable nonionic surfactants include polyhydroxy fatty acid amides of the formula

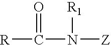

wherein R is a C₉₋₁₇ alkyl or alkenyl, R₁ is a methyl group and Z is glycityl derived from a reduced sugar or alkoxylated derivative thereof. Examples are N-methyl N-1-deoxyglucityl cocoamide and N-methyl N-1-deoxyglucityl oleamide. Processes for making polyhydroxy fatty acid amides are known and can be found in Wilson, U.S. Pat. No. 2,965,576 and Schwartz, U.S. Pat. No. 2,703,798, the disclosures of which are incorporated herein by reference

In addition to the anionic and nonionic surfactants describe, the compositions of the present invention may also contain cationic, amphoteric, or zwitterionic surfactants, typically added to improve surfactancy. Preferred cationic surfactants include amine oxides, for example, C8-C 16 alkyl dimethylamine N-oxides, or amino functional surfactants.

Mixtures of surfactants, such as LAS (linear alkyl benzene sulfonate) in combination with a co-surfactant such as ethoxylated alkyl sulfate (such as AES) and/or nonionic surfactant may also be used herein.

Detersive surfactants such as those disclosed in U.S. Pat. No. 5,466,802 to Panandiker, Issued Nov. 14, 1995, assigned to Procter & Gamble, may also be used herein.

IV. Substantially Free of Optical Brightener

The compositions of the present invention contain very low levels of optical brighteners that react with the polymeric dye transfer inhibiting agent to cause unacceptable product cloudiness. Preferably, the level of optical brightener in the composition is less than about 0.02%.

However, it is possible that certain optical brighteners, which do not react with the polymeric dye transfer inhibiting agent may be included in the compositions of the present invention at levels somewhat higher than 0.02%. To determine whether a given brightener may be included in the compositions of the present invention, and at what level, a product cloudiness determination may be made. Product cloudiness does not necessarily affect the performance of a given composition, but it is often aesthetically unacceptable to the consumer. To determine the product cloudiness attributable to the inclusion of optical brightener, a simple comparison test may be utilized. First, a sample of a brightener-free detergent composition is dosed with a specified amount of optical brightener and mixed well. The mixture is stored for 48 hours at 70° F. Then, the optical absorbance of both the control brightener-free detergent and the optical brightener-containing detergent are measured at a wavelength well removed from brightener fluorescence emission and intrinsic product absorbance (for example, 750 nm for a typical nominally blue liquid laundry formulation). Such readings provide a measure of transmitted light loss due to both intrinsic absorbance and loss due to scattering in cloudy product. The readings are compared. If the increase in absorbance readings from the control to the brightener-containing composition are equal to or less than about 0.15 absorbance units, then the product is considered to have an acceptable level of cloudiness. These measurements may be used to determine the maximum level of a given brightener that may be included in the formula. Preferably, the compositions of the present invention containing brightener have an increase of less than 0.05 absorbance units, and more preferably, no detectable change in optical absorbance if a brightener is included, in comparison to a brightener-free control composition.

For example, 1,3,5-Triazinyl derivatives of 4,4′-diaminostilbene-2,2′-disulfonic acid is the class of optical brightener generally referred to as triazinylaminostilbene brighteners. Brighteners in the class of triazinylaminostilbenes have been found to complex with the polymeric dye transfer inhibiting agent and cause undesirable cloudiness in the formula. By using the above comparison test, it was determined that the compositions of the present invention should contain less than 0.02%, by weight of the composition, of the trizinylaminostilbene brightener sold under the tradename “Tinopal-UNPA-GX” (discussed below) in order to avoid unacceptable product cloudiness.

Triazinyl aminostilbene optical brighteners generally conform to the following structural formula:

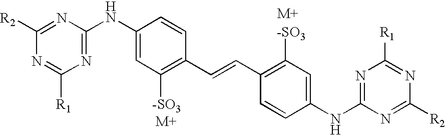

wherein R₁ may be selected from anilino, N-2-bis-hydroxyethyl and NH-2-hydroxyethyl; R₂ is selected from N-2-bis-hydroxyethyl, N-2-hydroxyethyl-N-methylamino, morpholino, chloro and amino; and M is a salt-forming cation such as sodium or potassium.

When in the above formula R₁ is anilino, R₂ is N-2-bis-hydroxyethyl and M is a cation such as sodium, the brightener is 4,4′-bis[(4-anilino-6-(N-2-bis-hydroxyethyl)-s-triazine-2-yl)amino]-2,2′-stilbenedisulfonic acid disodium salt. This particular brightener species is commercially marketed under the tradename Tinopal-UNPA-GX by Ciba-Geigy Corporation.

When in the above formula, R₁ is anilino, R₂ is morpholino and M is a cation such as sodium, the brightener is 4,4,′-bis[(4-anilino-6-morphilino-s-triazine-2-yl)amino]-2,2′-stilbenedisulfonic acid, sodium salt. This particular brightener species is commercially marketed under the tradename Tinopal AMS-GX by Ciga-Geigy Corporation.

Brighteners in other classes can also cause unacceptable product cloudiness. Ciba Tinopal CBS can cause product cloudiness at levels of 0.05% or greater, by weight of the composition, when included in compositions of the present invention. Tinopal CBS is a distyrylbiphenyl and is in the carbocycle class of optical brighteners.

Preferably, the compositions of the present invention contain only very low levels of optical brighteners in the triazinylaminostilbene or carbocycle classes, where the acceptable level of brightener is determined by the amount of cloudiness developed in a given detergent formulation. Other brighteners may be present in the formulation, provided that they do not cause unacceptable product cloudiness as determined by the comparison test set out above. More preferably, the compositions of the present invention are substantially free of all hydrophilic optical brightener. Even more preferably, the compositions of the present invention are substantially free of all optical brighteners. Optical brighteners, including triazinylaminostilbenes, are more fully discussed in Ullman's Encyclopedia of Industrial Chemistry, Fifth Edition, Vol. A18, Pages 153 to 176.

As used herein, “substantially free” of brightener means that the compositions of the present invention contains less than or equal to about 0.02%, by weight of the composition, of the brightener. Preferably, the compositions of the present invention contain less than about 0.001%, more preferably contain less than about 0.0001%, more preferably contain no detectable percentage, of brightener.

### Optional Ingredients

The compositions of the present invention may contain one or more additional liquid laundry detergent components. Classifications herein are made for the sake of convenience and are not intended to limit the ingredient to that particular application or applications listed.

Builders

The laundry detergent compositions of the present invention preferably comprise one ore more detergent builders or builder systems. When present, the compositions will typically comprise from about 1% builder, preferably from about 5%, more preferably from about 10% to about 80%, preferably to about 50%, more preferably to about 30% by weight, of detergent builder.

Inorganic or phosphorus-containing detergent builders include, but are not limited to, the alkali metal, ammonium and alkanolammonium salts of polyphosphates (exemplified by the tripolyphosphates, pyrophosphates, and glassy polymeric meta-phosphates), phosphonates, phytic acid, silicates, carbonates (including bicarbonates and sesquicarbonates), sulfates, and aluminosilicates. Phosphate builders may not be appropriate for use in some U.S. formulations due to environmental constraints. Non-phosphate builders are required in some locales. Importantly, the compositions herein function surprisingly well, even in the presence of the so-called “weak” builders (as compared with phosphates) such as citrate, or in the so-called “underbuilt” situation that may occur with zeolite or layered silicate builders.

Examples of silicate builders are the alkali metal silicates, particularly those having a SiO₂:Na₂O ratio in the range of 1.6:1 to 3.2:1 and layered silicates, such as the layered sodium silicates described in U.S. Pat. No. 4,664,839 to Rieck, issued May 12, 1987. NaSKS-6 is the trademarke for a crystalline layered silicate marketed by Hoechst (commonly abbreviated herein as “SKS-6”). Unlike zeolite builders, the NaSKS-6 silicate builder does not contain aluminum. Various other layered silicates from Hoechst include NaSKS-5, NaSKS-7 and NaSKS-11, as the alpha, beta and gamma forms.

Examples of carbonate builders are the alkaline earth and alkali metal carbonates as disclosed in German Patent Application No. 2,321,001 published on Nov. 15, 1973.

Organic detergent builders suitable for the purposes of the present invention include, but are not restricted to, a wide variety of polycarboxylate compounds. As used herein, “polycarboxylate” refers to compounds having a plurality of carboxylate groups, preferably at least 3 carboxylates. Polycarboxylate builder can generally be added to the composition in acid form, but can also be added in the form of a neutralized salt. When utilized in salt form, alkali metals, such as sodium potassium, and lithium, or alkanolammonium salts are preferred.

Included among the polycarboxylate builders are the following categories of useful materials: ether polycarboxylates (including oxydisuccinate); “TMS/TDS” builders of U.S. Pat. No. 4,663,071 to Bush, et al., issued May 5, 1987. Other suitable ether polycarboxylates include cyclic compounds, particularly alicyclic compounds.

Other useful detergency builders include the ether hydroxypolycarboxylates, copolymers of maleic anhydride with ethylene or vinyl methyl ether, 1,3,5-trihydroxy benzene-2,4,6-trisulfonic acid, and carboxymethyloxysuccinic acid, the various alkali metal, ammonium and substituted ammonium salts of polyacetic acids such as ethylenediamine tetraacetic acid and nitrilotriacetic acid, as well as polycarboxylates such as mellitic acid, succinic acid, oxydisuccinic acid, polymaleic acid, benzene 1,3,5-tricarboxylic acid, carboxymethyloxysuccinic acid, and soluble salts thereof.

Citrate builders, e.g., citric acid and soluble salts thereof (particularly sodium salt), are polycarboxylate builders of particular importance for heavy duty liquid detergent formulations due to their availability from renewable resources and their biodegradability.

Also suitable in the detergent compositions of the present invention are the 3,3-dicarboxy-4-oxa-1,6-hexanedioates and the related compounds disclosed in U.S. Pat. No. 4,566,984, Bush, issued Jan. 28, 1986. Useful succinic acid builders include the C₅-C₂₀ alkyl and alkenyl succinic acids and salts thereof. A particularly preferred compound of this type is dodecenylsuccinic acid. Specific examples of succinate builders include: laurylsuccinate, myristylsuccinate, palmitylsuccinate, 2-dodecenylsuccinate (preferred), 2-pentadecenylsuccinate, and the like. Laurylsuccinates are the preferred builders of this group.

Other suitable polycarboxylates are disclosed in U.S. Pat. No. 4,144,226, Crutchfield, et al, issued Mar. 13, 1979 and in U.S. Pat. No. 3,308,067, Diehl, issued Mar. 7, 1967.

Fatty acids, e.g., C₁₂-C₁₈ monocarboxylic acids, can also be incorporated into the compositions alone, or in combination with the aforesaid builders, especially citrate and/or the succinate builders, to provide additional builder activity. Such use of fatty acids will generally result in a diminution of sudsing, which should be taken into account by the formulator.

Phosphonate builders such as ethane-1-hydroxy-1,1-diphosphonate and other known phosphonates, can also be used.

Dispersants

Any suitable clay/soil dispersant or anti-redeposition agent can be used in the laundry compositions of the present invention. Polylalkyleneimine dispersants, which are known in the art, may also be used in the compositions of the present invention.

Acrylic/maleic-based copolymers may also be used as a preferred component of the dispersing/anti-redeposition agent. Such materials include the water-soluble salts of copolymers of acrylic acid and maleic acid. The average molecular weight of such copolymers in the acid form preferably ranges from about 2,000, more preferably from about 5,000, more preferably from about 7,000 to 100,000, more preferably to 75,000, most preferably to 65,000. The ratio of acrylate to maleate segments in such copolymers will generally range from about 30:1 to about 1:1, more preferably from about 10:1 to 2:1. Water-soluble salts of such acrylic acid/maleic acid copolymers can include, for example, the alkali metal, ammonium and substituted ammonium salts. Such polymers may also comprise hydroxypropylacrylate. Still other dispersing agents include the maleic/acrylic/vinyl alcohol terpolymers.

Another polymeric material which can be included is polyethylene glycol (PEG). PEG can exhibit dispersing agent performance as well as act as a clay soil removal-antiredeposition agent. Typical molecular weight ranges for these purposes range from about 500 to about 100,000, preferably from about 1,000 to about 50,000, more preferably from about 1,500 to about 10,000.

Polyaspartate and polyglutamate dispersing agents may also be used, especially in conjunction with zeolite builders. Dispersing agents such as polyaspartate preferably have a molecular weight (avg.) of about 10,000.

Soil Release Agents

The compositions according to the present invention may optionally comprise one or more soil release agents. If utilized, soil release agents will generally comprise from about 0.01%, preferably about 0.1%, more preferably from about 0.2% to about 10%, preferably to about 5%, more preferably to about 3% by weight, of the composition. Polymeric soil release agents are characterized by having both hydrophilic segments, to hydrophilize the surface of hydrophobic fibers, such as polyester and nylon, and hydrophobic segments, to deposit upon hydrophobic fibers and remain adhered thereto through completion of the laundry cycle and, thus, serve as an anchor for the hydrophilic segments. This can enable stains occurring subsequent to treatment with the soil release agent to be more easily cleaned in later washing procedures.

The following references describe non-limiting examples of soil release polymers suitable for use in the present invention. U.S. Pat. No. 5,728,671 to Rohrbaugh, et al., issued Mar. 17, 1998; U.S. Pat. No. 5,691,298 to Gosselink, et al., issued Nov. 25, 1997; U.S. Pat. No. 5,599,782 to Pan, et al., issued Feb. 4, 1997; U.S. Pat. No. 5,415,807 to Gosselink, et al., issued May 16, 1995; U.S. Pat. No. 5,182,043 to Morrall, et al., issued Jan. 26, 1993; U.S. Pat. No. 4,956,447 to Gosselink, et al., issued Sep. 11, 1990; U.S. Pat. No. 4,976,879 to Maldonado, et al., issued Dec. 11, 1990; U.S. Pat. No. 4,968,451 to Scheibel, et al., issued Nov. 6, 1990; U.S. Pat. No. 4,925,577 to Borcher, Sr., et al., issued May 15, 1990; U.S. Pat. No. 4,861,512 to Gosselink, issued Aug. 29, 1989; U.S. Pat. No. 4,877,896 to Maldonado, et al., issued Oct. 31, 1989; U.S. Pat. No. 4,721,580 to Gosselink, issued Jan.26, 1988.

The detergent compositions of the present invention may comprise other soil release agents known in the art. The compositions may also comprise mixtures of two or more soil release agents.

Other Optional Components

The detergent composition of the present invention can also include any number of additional optional ingredients. These include conventional detergent composition components such as suds boosters or suds suppressers, anti-tarnish and anticorrosion agents, soil suspending agents, soil release agents, germicides, pH adjusting agents, non-builder alkalinity sources, chelating agents, smectite clays, enzymes, enzyme-stabilizing agents and perfumes. (See, U.S. Pat. No. 3,936,537, issued Feb. 3, 1976 to Baskerville, Jr. et al., See also, U.S. Pat. No. 4,285,841, Barrat et al., issued Aug. 25, 1981, and See also, U.S. Pat. No. 4,844,824 Mermelstein et al., issued Jul. 4, 1989).

Additional dye transfer inhibiting agents and additional optical brighteners may also be included. For example, polyvinylpyridine N-oxide (PVNO) is a suitable dye transfer inhibiting polymer for use in the present detergent composition. Furthermore, additional relatively hydrophobic brighteners optionally may be employed. However, the detergent compositions herein are preferably substantially free of all optical brighteners.

Chelating agents are described in U.S. Pat. No. 4,663,071, Bush et al., from Column 17, line 54 through Column 18, line 68, and are also described in U.S. Pat. No. 4,909,953, Sadlowski, et al. issued Mar. 20, 1990. Suds modifiers are also optional ingredients and are described in U.S. Pat. Nos. 3,933,672, issued Jan. 20, 1976 to Bartoletta et al., and 4,136,045, issued Jan. 23, 1979 to Gault et al. Suitable smectite clays for use herein are described in U.S. Pat. No. 4,762,645, Tucker et al, issued Aug. 9, 1988, Column 6, line 3 through Column 7, line 24, incorporated herein by reference.

While not essential to the detergent composition of the invention, it is preferable to include an enzyme component. Suitable enzyme components are available from a wide variety of commercial sources. For example, suitable enzymes are available from NOVO Industries under product names T-Granulate™ and Savinase™, and Gist-Brocades under product names Maxacal™and Maxatase™. Included within the group of enzymes are proteases, amylases, lipases, cellulases and mixtures thereof. A preferred cellulase enzyme is Carezyme™. The enzyme concentration preferably should be from about 0% to about 5%, more preferably from about 0.1% to about 2.5%, and most preferably from about 0.2% to about 1%. Typically, proteases are used at an Activity Unit (Anson Unit) level of from about 0.001 to about 0.05, most preferably from about 0.002 to about 0.02, while amylases are used at an amylase unit level of from about 5 to about 5000, most preferably from about 50 to about 500 per gram of detergent composition.

Thickeners such as trihydroxystearin may also be used herein.

Detergent Composition Formulation

The detergent compositions according to the present invention are in liquid form. Liquid detergent compositions can be prepared by admixing the essential and optional ingredients thereof in any desired order to provide compositions containing components in the requisite concentrations. Liquid compositions according to the present invention can also be in “compact form”, in such case, the liquid detergent compositions according to the present invention will contain a lower amount of water, compared to conventional liquid detergents. The chlorine scavenger can be dissolved or can be suspended. If the chlorine scavenger is solid, rapidly dissolving forms for wash bath are preferred.

The detergent compositions may be isotropic or non-isotropic liquids, may be Newtonian, or non-newtonian. The detergent compositions may be structured liquids, both internally and/or externally structured. Preferably, the compositions of the present invention are isotropic liquids.

Detergent Packaging

The detergent compositions according to the present invention may be presented to the consumer in standard packaging, or may be presented in any suitable packaging. Recently, multiple compartment bottles containing multiple formulations that are dispensed and combined have become used for detergent compositions. The compositions of the present invention may be formulated for inclusion in such packages. In addition, unit dose packages have also become commonly used for detergent compositions. Such packages are also suitable for use with the compositions of the present invention.

Methods of Use

The present invention also provides a method for improved laundering of colored fabrics. Such a method employs contacting these fabrics with an aqueous washing solution formed from an effective amount of the detergent compositions hereinbefore described. Contacting of fabrics with washing solution will generally occur under conditions of agitation.

Agitation is preferably provided in a washing machine for good cleaning. Washing is preferably followed by drying the wet fabric in a conventional clothes dryer. An effective amount of the liquid detergent composition in the aqueous wash solution in the washing machine is preferably from about 500 to about 7000 ppm, more preferably from about 1000 to about 3000 ppm, under typical U.S. washing conditions. In the newer high efficiency (HE) washing machines, higher product concentrations are delivered to fabric, and therefore soil and dye-loads in the wash solution are even higher. Product concentration and raw material levels are thereby adjusted to accommodate these changes in wash conditions due to washing machine changes.

### EXAMPLES

The following examples A through X further describe and demonstrate embodiments within the scope of the present invention. The examples are given solely for the purpose of illustration and are not to be construed as limitations of the present invention, as many variations thereof are possible without departing from the spirit and scope of the invention.

All of these compositions provide an acceptable level of product cloudiness and provide effective cleaning of colored fabrics while reducing dye transfer and fading. All percentages are listed by weight of the composition formed.

### Examples A-D

Liquid laundry detergents according to the present invention having improved performance with colored fabrics are prepared by conventional means:

| Component | A | B | C | D |
|---|---|---|---|---|
| Linear Alkyl Benzene | 3.0 | 1.5 | 12 | 10.0 |
| Sulfonate | | | | |
| Alkyl Ethoxy Sulfate | 9.5 | 8.5 | | 7.0 |
| Fatty alcohol ethoxylate | 1.5 | 1.5 | 8 | 6.0 |
| (9EO) | | | | |
| Sodium Citrate | | | | 5.0 |
| Citric Acid | 1.5 | 3.0 | 1.0 | |
| Fatt Acid | 0.5 | 0.5 | 4.0 | |
| Enzymes | 1.0 | 1.0 | | 2.0 |
| Borax | 1.5 | 0.75 | | 3.0 |
| Soil Release Polymers | 1.0 | 2.0 | | 2.0 |
| Ethanol | 1.5 | 1.0 | | |
| Propanediol | 3.0 | 3.0 | 8.0 | |
| Propylene Glycol | | | | 8.0 |
| Sorbitol | | | | 4.5 |
| Monoethanolamine | 2.0 | 2.0 | 3.0 | 2.0 |
| PVPVI | 0.1 | 0.1 | 0.1 | 0.5 |

| | |
|---|---|
| Water/Minors | Balance up to 100% |

### Examples E-G

Liquid laundry detergents according to the present invention having improved performance with colored fabrics are prepared by conventional means:

| Component | E | F | G |
|---|---|---|---|
| Alkyl Sulfate | 10.0 | | |
| Linear Alkyl Benzene | | 5.0 | 10.0 |
| Sulfonate | | | |
| Alkyl Ethoxy Sulfate | 7.0 | 15.0 | |
| Fatty alcohol ethoxylate (9EO) | 6.0 | 2.0 | 10.0 |
| Amine Oxide | | 1.0 | |
| Sodium Citrate | 5.0 | | |
| Citric Acid | | 3.0 | 3.0 |
| Fatty Acid | | 3.0 | 8.0 |
| Enzymes | 2.0 | 1.3 | 1.1 |
| Borax | 3.0 | 1.5 | 1.5 |
| Soil Release Polymers | 2.0 | 2.0 | 2.7 |
| Ethanol | | 2.5 | 2.0 |
| Propanediol | | 5.0 | 5.0 |
| Propylene Glycol | 8.0 | | |
| Glycerine | | 3.0 | |
| Sorbitol | 4.5 | | |
| Monoethanolamine | 2.0 | 1.5 | 4.0 |
| PVPVI | 0.5 | 0.2 | 0.2 |

| | |
|---|---|
| Water/Minors | Balance up to 100% |

### Examples H-K

Liquid laundry detergents according to the present invention having improved performance with colored fabrics are prepared by conventional means:

| Component | H | I | J | K |
|---|---|---|---|---|
| Linear Alkyl Benzene | 3.0 | 3.0 | 12 | 12 |
| Sulfonate | | | | |
| Alkyl Ethoxy Sulfate | 9.5 | 9.5 | | |
| Fatty alcohol | 1.5 | 1.5 | 8 | 8 |
| ethoxylate (9EO) | | | | |
| Citric Acid | 1.5 | 1.5 | 1.0 | 1.0 |
| Fatty Acid | 0.5 | 0.5 | 4.0 | 4.0 |
| Enzymes | 1.0 | 1.0 | | |
| Borax | 1.5 | 1.5 | | |
| Soil Release Polymers | 1.0 | 1.0 | | |
| Ethanol | 1.5 | 1.5 | | |
| Propanediol | 3.0 | 3.0 | 8.0 | 8.0 |
| Monoethanolamine | 2.0 | 2.0 | 3.0 | 3.0 |
| PVPVI | 0.1 | | 0.1 | 0.1 |
| PVP | | 0.2 | | |
| PVNO | | | | 0.1 |

| | |
|---|---|
| Water/Minors | Balance up to 100% |

### Examples L-O

Liquid laundry detergents according to the present invention having improved performance with colored fabrics are prepared by conventional means:

| Component | L | M | N | O |
|---|---|---|---|---|
| Alkyl Sulfate | 10.0 | 10.0 | | |
| Linear Alkyl Benzene | | | 10.0 | 10.0 |
| Sulfonate | | | | |
| Alkyl Ethoxy Sulfate | 7.0 | 7.0 | | |
| Fatty alcohol ethoxylate | 6.0 | 6.0 | 10.0 | 10.0 |
| (9EO) | | | | |
| Sodium Citrate | 5.0 | 5.0 | | |
| Citric Acid | | | 3.0 | 3.0 |
| Fatty Acid | | | 8.0 | 8.0 |
| Enzymes | 1.0 | 1.0 | 1.1 | 1.1 |
| Borax | 3.0 | 3.0 | 1.5 | 1.5 |
| Soil Release Polymers | 1.0 | 1.0 | 2.7 | 2.7 |
| Ethanol | | | 2.0 | 2.0 |
| Propanediol | | | 5.0 | 5.0 |
| Propylene Glycol | 8.0 | 8.0 | | |
| Sorbitol | 4.5 | 4.5 | | |
| Monoethanolamine | 2.0 | 2.0 | 4.0 | 4.0 |
| PVPVI | 0.5 | | 0.05 | |
| PVP | | 1.0 | | 0.1 |

| | |
|---|---|
| Water/Minors | Balance up to 100% |

### Examples P-S

Liquid laundry detergents according to the present invention having improved performance with colored fabrics are prepared by conventional means:

| Component | P | Q | R | S |
|---|---|---|---|---|
| Linear Alkyl Benzene | 3.0 | 3.0 | 12 | 12 |
| Sulfonate | | | | |
| Alkyl Ethoxy Sulfate | 9.5 | 9.5 | | |
| Fatty alcohol ethoxylate | 1.5 | 1.5 | 8 | 8 |
| (9EO) | | | | |
| Sodium Citrate | | | | |
| Citric Acid | 1.5 | 1.5 | 1.0 | 1.0 |
| Fatty Acid | 0.5 | 0.5 | 4.0 | 4.0 |
| Enzymes | 1.0 | 1.0 | | |
| Borax | 1.5 | 1.5 | | |
| Soil Release Polymers | 1.0 | 1.0 | | |
| Ethanol | 1.5 | 1.5 | | |
| Propanediol | 3.0 | 3.0 | 8.0 | 8.0 |
| Monoethanolamine | 2.0 | 5.0 | | |
| Diethylene triamine | | | 3.5 | |
| Polyethyleneimine | | | | 5.0 |
| PVPVI | 0.1 | 0.2 | 0.1 | 0.2 |

| | |
|---|---|
| Water/Minors | Balance up to 100% |

### Examples T-W

Liquid laundry detergents according to the present invention having improved performance with colored fabrics are prepared by conventional means:

| Component | T | U | V | W |
|---|---|---|---|---|
| Alkyl Sulfate | 10.0 | 10.0 | | |
| Linear Alkyl | | | 10.0 | 10.0 |
| Benzene Sulfonate | | | | |
| Alkyl Ethoxy | 7.0 | 7.0 | | |
| Sulfate | | | | |
| Fatty alcohol | 6.0 | 6.0 | 10.0 | 10.0 |
| ethoxylate (9EO) | | | | |
| Sodium Citrate | 5.0 | 5.0 | | |
| Citric Acid | | | 3.0 | 3.0 |
| Fatty Acid | | | 8.0 | 8.0 |
| Enzymes | 1.0 | 1.0 | 1.1 | 1.1 |
| Borax | 3.0 | 3.0 | 1.5 | 1.5 |
| Soil Release | 1.0 | 1.0 | 2.7 | 2.7 |
| Polymers | | | | |
| Ethanol | | | 2.0 | 2.0 |
| Propanediol | | | 5.0 | 5.0 |
| Propylene Glycol | 8.0 | 8.0 | | |
| Sorbitol | 4.5 | 4.5 | | |
| Monoethanolamine | 5.0 | | | |
| Diethylene triamine | | 6.5 | 5.0 | |
| Polyethyleneimine | | | | 6.0 |
| PVPVI | 0.5 | 0.5 | 0.05 | 0.05 |

| | |
|---|---|
| Water/Minors | Balance up to 100% |

### Example X

Liquid laundry detergents according to the present invention having improved performance with colored fabrics are prepared by conventional means:

| Component | X |
|---|---|
| Linear Alkyl Benzene | 3.0 |
| Sulfonate | |
| Alkyl Ethoxy Sulfate | 9.5 |
| Fatty alcohol ethoxylate (9EO) | 1.5 |
| Citric Acid | 1.5 |
| Fatty Acid | 0.5 |
| Enzymes | 1.0 |
| Borax | 1.5 |
| Soil Release Polymers | 1.0 |
| Ethanol | 1.5 |
| Propanediol | 3.0 |
| Monoethanolamine | 2.0 |
| PVPVI | 0.1 |
| Tinopal-UNPA-GX | 0.005 |
| Water/Minors | Balance |

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A liquid laundry detergent composition having improved color care capability comprising:
a) an effective amount of a chlorine scavenger;
b) a polymeric dye transfer inhibiting agent; and
c) a detersive surfactant; wherein
d) the composition is substantially free of triazinylaminostilbene optical brightener.

2. A laundry detergent composition according to claim 1 wherein the composition comprises from about 0.001% to about 10%, by weight of the composition, of the polymeric dye transfer inhibiting agent.

4. A laundry detergent composition according to claim 2 wherein the composition comprises from about 1% to about 80%, by weight of the composition, of the detersive surfactant.

5. A laundry detergent composition according to claim 1 wherein the composition contains less than 0.001% total optical brightener.

6. A laundry detergent according to claim 1 wherein the composition comprises from about 0.1% to about 20% of the chlorine scavenger.

7. A laundry detergent according to claim 6 wherein the chlorine scavenger is selected from the group consisting of amines and mixtures thereof.

8. A laundry detergent according to claim 7 wherein the chlorine scavenger is monoethanolamine.

9. A laundry detergent composition according to claim 1 wherein the detersive surfactant is selected from the group consisting of anionic surfactants, nonionic surfactants, and mixtures thereof.

10. A laundry detergent composition according to claim 4 wherein the detersive surfactant is selected from the group consisting of linear alkyl sulfonate, ethoxylated alkyl sulfate, and mixtures thereof.

11. A laundry detergent composition according to claim 1 wherein the composition further comprises a builder.

12. A laundry detergent composition according to claim 1 wherein the composition further comprises an enzyme.

13. A liquid laundry detergent composition comprising:
a) from about 1% to about 10%, by weight of the composition, of a chlorine scavenger selected from the group consisting of amines and mixtures thereof;
b) from about 0.05% to about 1.0%, by weight of the composition, of a polymeric dye transfer inhibiting agent selected from the group consisting of polyvinylpyrrolidone, copolymers of poly(N-vinyl-2-pyrollidone) and poly(N-vinyl-imidazole), and mixtures thereof; and
c) a detersive surfactant; wherein
d) the composition is substantially free of hydrophilic optical brightener.

14. A laundry detergent according to claim 13 wherein the chlorine scavenger is monoethanolamine.

15. A laundry detergent according to claim 14 wherein the polymeric dye transfer inhibiting agent is a copolymer of poly(N-vinyl-2-pyrollidone) and poly(N-vinyl-imidazole).

16. A laundry detergent according to claim 13 wherein the composition comprises less than 0.0001% total optical brightener.

17. A laundry detergent according to claim 16 wherein the composition further comprises a builder selected from the group consisting of aluminosilicates, crystalline layered silicates, citrates, and mixtures thereof.

18. A laundry detergent composition according to claim 16 wherein the composition further comprises an enzyme selected from the group consisting of proteases, lipases, amylases, cellulases, and combinations thereof.

19. A laundry detergent composition according to claim 18 wherein the enzyme is a cellulase enzyme.

20. A laundry detergent composition according to claim 15 wherein the composition further comprises a suds suppressor.

21. A method of cleaning colored fabrics in the wash, said method comprising contacting said fabrics with a wash solution which contains an effective amount of a detergent composition according to claim 1.

22. A method of cleaning colored fabrics in the wash, said method comprising contacting said fabrics with a wash solution which contains an effective amount of a detergent composition according to claim 13.
